(19) United States
(12) Patent Application Publication
(10) Pub. No.: US 2002/0029188 A1
(43) Pub. Date: Mar. 7, 2002

(54) Method and apparatus to facilitate competitive financing activities among myriad lenders on behalf of one borrower

(76) Inventor: Stephen J. Schmid, Malvern, PA (US)

Correspondence Address: Kenneth N. Nigon, Ratner & Prestia, One Westlakes, Berwyn, Suite 301, P. O. Box 980, Valley Forge, PA, 19482-0980, US

(21) Appl. No.: 09/742,791

(22) Filed: Dec. 20, 2000

Related U.S. Application Data
(60) Provisional application No. 60/172,736, filed on Dec. 20, 1999.

(51) Int. Cl. G06F 17/60

(52) U.S. Cl. 705/38; 705/35

(57) ABSTRACT

A computerized system for negotiating loans on behalf of a borrower collects data on a desired loan transaction in electronic form. Next, the system electronically notifies a plurality of lenders of the requested loan transaction and invites each lender to electronically submit a corresponding quote. The system posts the received quotes to a database that may be viewed by the borrower. The borrower selects quotes from the plurality of quotes, and the system invites the corresponding lenders to participate in a final quote event. In conducting the final quote event, the system displays the selected quotes to the borrower and also displays, to each lender, the lender's current quote and the best terms from among the multiple remaining quotes. Each lender is also provided with options to improve their corresponding quote. After a period of negotiation, the borrower selects one quote from among the multiple quotes as the final quote.

### BACKGROUND

The present invention concerns interactive computer software for use in brokering loans and in particular to a system which foster competition among lenders for the benefit of a borrower.

In establishing a new market and the related practices for the facilitation of global commercial lending via the Internet, one need comprehend how the current marketplace works. When a business needs to borrow funds for its operations, or to purchase assets (or to lease them) a company executive calls on its lending sources and describes what the loan is needed for and how the loan proceeds will be repaid. The lending source may be a banker, investment banker, financial broker, pension fund advisor, insurance company, intermediary, or high net worth individual. The lending source may be a specialist in commercial/resort real estate, equipment leasing, or asset based lending.

Depending upon the company's manpower, the borrower may call on three, four, five or more lending sources or financial intermediaries and discuss his/her borrowing request with each of them. The borrower forwards a package of financial data to each lending source that has expressed an interest in the loan request. Often a borrower will contact locally based lending sources to repeat this process time and time again. Then, the borrower waits for a response. Depending upon a number of factors such as: the quality and completeness of the financial data; style of presentation; business sector; reputation of the borrowing entity and its managers/owners; quality of the assets to be pledged as collateral; location of the business; revenue streams; AND the lending source's workload and availability of funds, one or more lending sources may respond with a rejection, more questions about the loan request or a term sheet. Some lending sources may not respond at all leaving the borrower to wonder about the status of his loan request.

A borrower may negotiate one lending source's terms against another to improve his position. In looking for advice during this process, a borrower may call upon his/her atterney, accountant or other financial advisor. The borrower should know that the lending sources or brokers representing the lending sources are not unbiased parties. Some borrowers mistakenly believe that loan brokers or real estate lending correspondent's represent their interests. Not so. These intermediaries work for the lender of capital, not the borrower.

Once the borrower has chosen a lending source, an application is signed, and due diligence commences. Third party reports are ordered and the borrower waits for the results, which, if successful, culminate when the lending source issues a commitment letter to fund the loan.

A borrower who works through this conventional process to select the lending source he/she wants to work with makes decisions about loan terms that may conclude with a loan funding. One can deduce that if the borrower accepts the terms of the loan, he/she must be satisfied or he/she would not have signed the loan documents and obligated himself or herself to its terms. This procedure has been the norm for the commercial lending process for years.

### SUMMARY OF THE INVENTION

The present invention creates a “marketspace” among borrowers and lending sources that takes full advantage of the global reach that the Internet provides. This marketspace is mediated by a web site that brings these two groups together in an interactive on-line, real-time environment to facilitate arranging commercial loans, globally.

The present invention is embodied in a computerized system and method for negotiating loans on behalf of a borrower. The system collects data on a desired loan transaction from the borrower, puts the data in electronic form and makes it available for on-line viewing. Next, the system electronically notifies multiple lenders of the available lending opportunity and invites each lender to electronically submit a corresponding quote. The system posts the received quotes to a database that may be viewed by the borrower at any time. The borrower selects quotes from the multiple quotes, and the system invites the corresponding lenders to participate in a final quote event. In conducting the final quote event, the system displays the selected quotes to the borrower and also displays, to each lender, the lender's current quote and a best terms from among the multiple remaining quotes. Each lender is also provided with options to improve their corresponding quote. After a period of negotiation, the borrower selects one quote from among the multiple lender's quotes as the final winning quote.

### BRIEF DESCRIPTION OF THE DRAWINGS

FIG. 1 is a flow-chart diagram that illustrates the environment in which the present invention is used.

FIG. 2 is a flow-chart diagram which illustrates the basic structure of the web-site of the company shown in FIG. 1.

FIGS. 3, 3A, 3B and 3C are flow-chart diagrams that illustrate the interaction of the borrower/client with the web site shown in FIG. 2.

FIGS. 4, 4A, 4B and 4C are flow-chart diagrams that illustrate the interaction of the lending sources with the web site shown in FIG. 2.

FIGS. 5, 5A, 5B, 5C, 5D and 5E are flow-chart diagrams that illustrate the interaction of the lending sources and the borrower/client with the web site shown in FIG. 2 before, during and after the final quote event.

### DETAILED DESCRIPTION

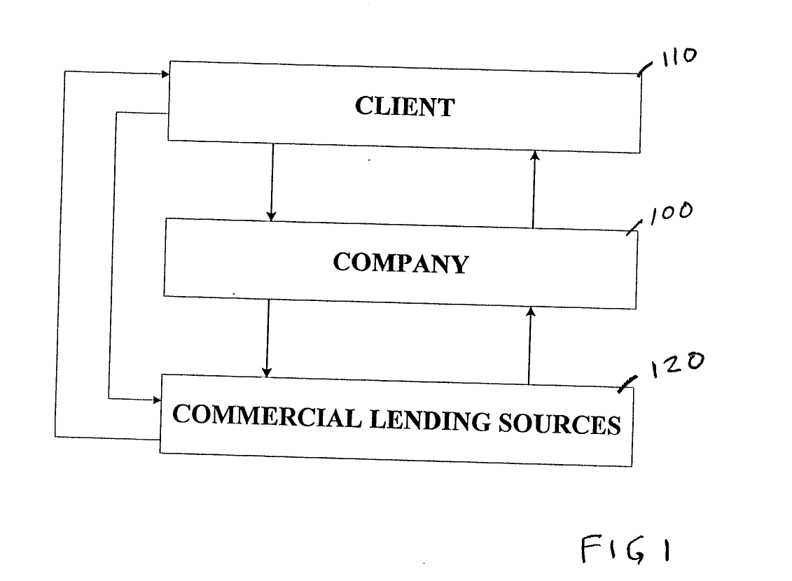

The present invention facilitates creation of a new global marketspace for arranging loans by bringing borrowers of capital and lenders of capital together, on-line, in real-time. The exemplary embodiment encompasses proprietary software, computer hardware, telecommunications (specifically, a global information network such as the Internet) and encrypted data transfer. It is contemplated, however, that other telecommunications facilities may be used, for example, a dedicated dial-up connection to the company's server. One aspect of the exemplary embodiment of the invention is a web site that may be viewed by both borrowers and lenders. With reference to FIG. 1, the web site functions to bring borrowers or clients 110 seeking capital and lenders 120 who provide capital together by utilizing proprietary software 100, which has been designed to facilitate real-time interactivity via the Internet. The invention has been modeled to foster a competitive environment among myriad lenders for the benefit of a borrower seeking capital. Utilization of the model benefits borrowers because it creates competition among lending sources for a single lending opportunity. The competitive forces that the model fosters tend to cause lending sources to reduce margins and improve terms, thus benefiting the borrower of capital.

The three areas of concentration that the exemplary embodiment of the invention operates in are equipment lease finance, commercial real estate finance and select bank lending.

The computer system uses an extensive database of capital sources including lending sources' requirements for various loan types, locational preferences, minimum and maximum loan amounts and terms. This database of lending sources is used by the subject invention to match loan requests from borrowers with the preferences of the lending sources. The subject invention empowers borrowers with more access to global capital sources than the current marketplace process offers.

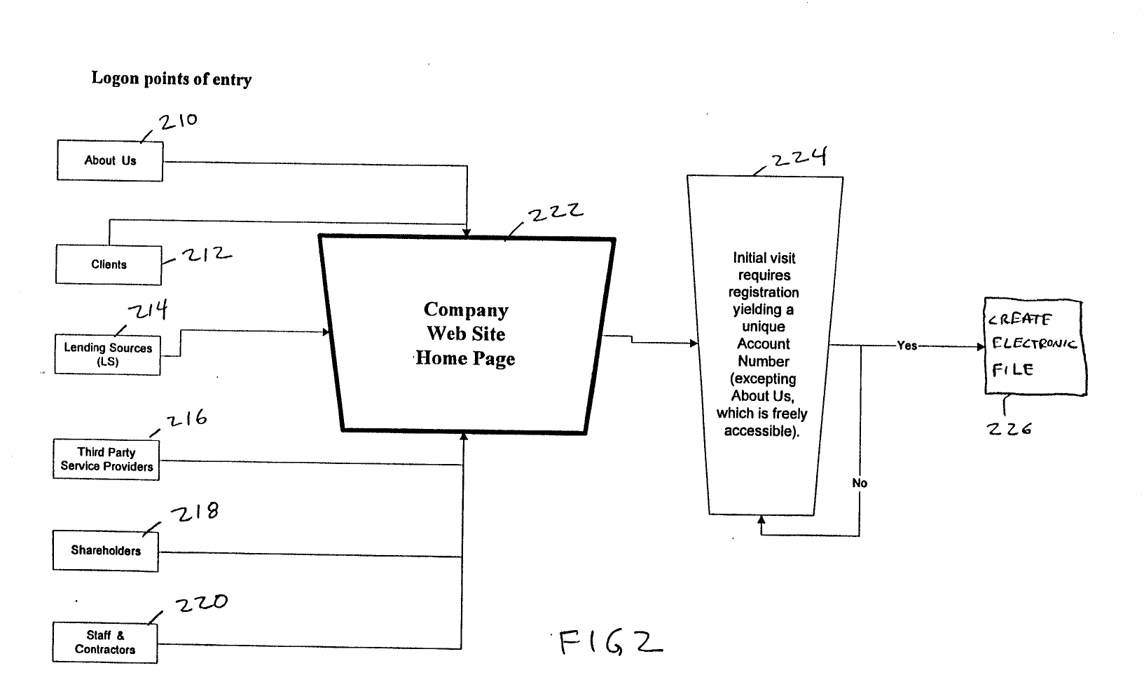

Because a summary of the borrower's loan request is made available to more lending sources via the Internet than the borrower could reach on his own, the interactive on-line, real time bidding model of the present invention creates a stable of lending sources seeking to fund the same project. When several lending sources looking at the same potential loan are combined with an interactive on-line, real time market that dynamically moves price and terms to more efficient levels, the borrower has an opportunity to more easily improve the terms of his loan. Contrast that with the world's current conventional market practices of funding loans in which terms are dictated by lending sources instead of competed over by them. As shown in FIG. 2, once a prospective borrower visits the website and reads about the Company 210 to gain an understanding of its business purpose and methods he/she makes a decision to register as a member. Then, the prospective borrower has the option of inputting 224 general data about himself or herself and the project, in a registration form which is sent to a central server via the Internet in an encrypted format. (Data transmissions originated in the United States utilize 128 bit encryption and non United States originated data transmissions utilize 40 bit encryption pursuant to Federal law.). As an alternative to step 224, a borrower may call to speak with a global capital specialist (GCS) about the company and the project. If the prospective borrower telephones the company, the GCS performs step 224, opening a new form and filling it out. This may be done during or after the telephone call. An account number is assigned to the prospective borrower once the form is submitted.

Because one of the Company's goals is to reach prospective borrowers and lenders globally, web site visitors have the ability to communicate with the company in English initially, and in other languages (e.g. Spanish, German, French, and Italian) thereafter.

Once the prospective borrower completes the form at step 224 and submits it, an automatic e-mail response is generated acknowledging that a GCS will be calling. If the GCS has completed the form an automatic e-mail response is sent to the prospective borrower. At step 226, an electronic file on the prospective borrower is created from the initial form. All subsequent communication, including e-mails, faxes, phone calls, and correspondence is entered into that borrower's file. This contract management format is designed to permit accessibility by the GCS responsible for that account and his/her workmates. Management 220, shareholders 218 and third-party service providers 216 may view certain aspects of the file at step 308. A secure record of all who access the file, when they access the file and an audit trail of the changes made is incorporated so as to provide an audit tool that notes all proper and improper changes made to the files. Some data from the file, such as name, address, phone numbers, e-mail, etc. may be “exportable” for other purposes such as specific deal tracking, letter writing campaigns, holiday greeting cards, event invitations, telephone call list, follow up and to do lists generation.

The contact management file contains a chronological summary noting all contact with the client. Specific details for each deal, step 310, are noted within a file for that deal. For example, the GCS may open a contact management file for prospective borrower X, which is established from the initial contact with him/her, to read about how the initial contact occurred in the notes section. If the contact management file or the project summary data are incomplete, the GCS completes it during the current call. The GCS then enters notes pertaining to the call and project being discussed and schedule follow up communication as necessary. Follow up contact is posted to the GCS's calendar automatically.

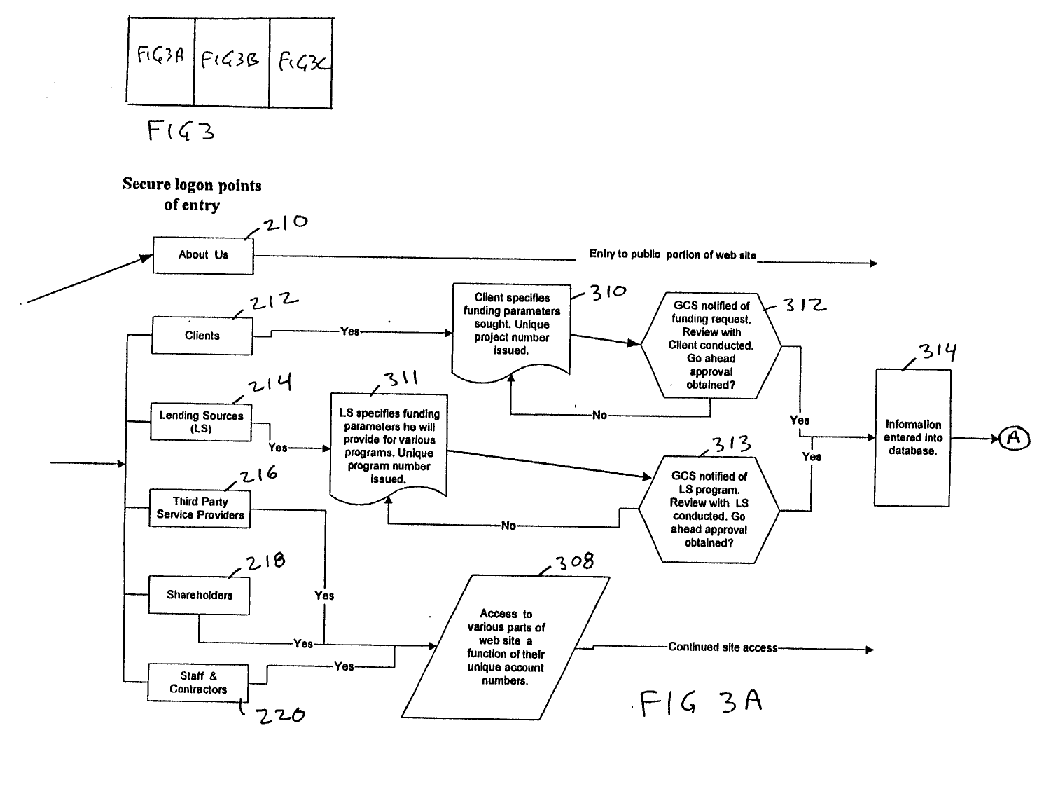

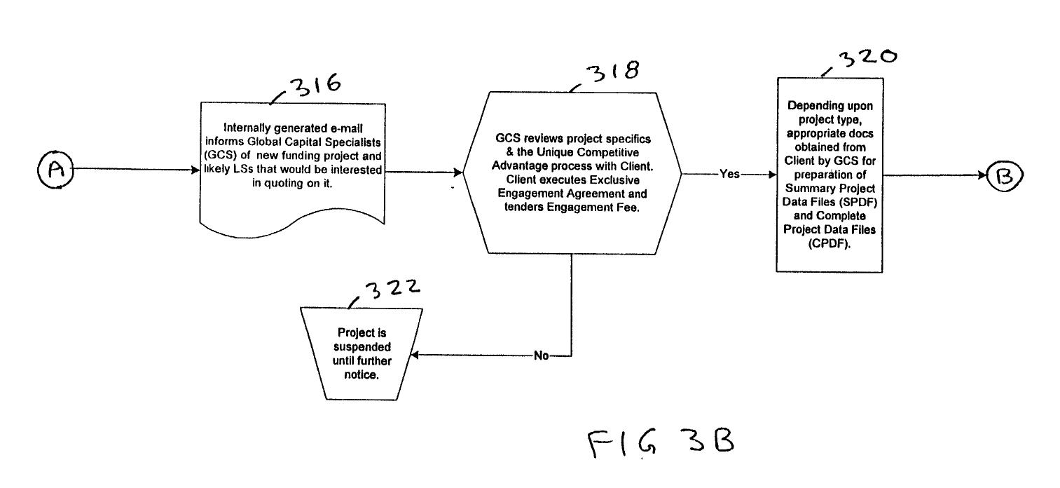

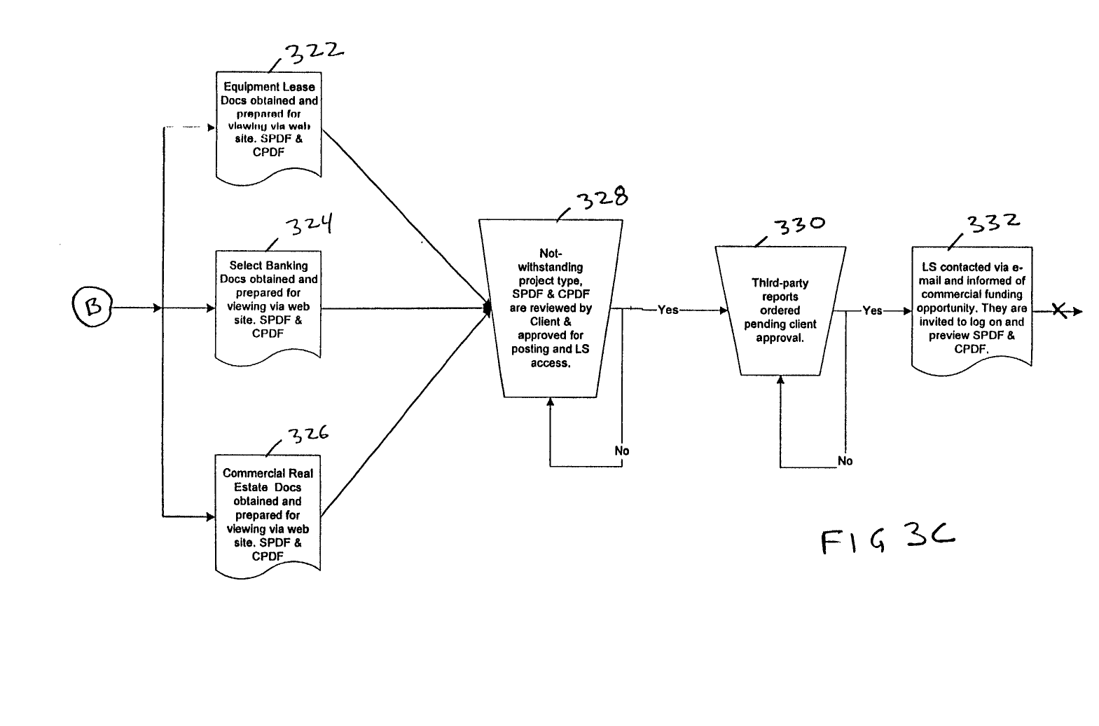

Lenders 214 may also register with the company using the process shown in FIG. 3A. At step 311, the lender completes a form that specifies the funding parameters that he will use for various programs. Once the Lender has completed the form, he/she is assigned a unique number to identify the lending program. After obtaining the form from the lender, the system, at step 313, notifies the GCS of the new lending program and the GCS reviews the lending program and works with the lender to define a lending program which fits the general parameters of the system.

Once the relationship develops with a borrower and a specific deal is being discussed, step 312, the details of that deal are maintained in a sub-file of the contact management file for that client. An account number is automatically assigned to the deal. The GCS goes to that sub-file and enters detailed information about the conversation with the client pertaining to that deal. The first line of notes from that sub-file automatically posts to the notes summary section of the main file for that prospective borrower. This way, when a GCS or manager looks at the main file for prospective borrower or client X, glancing at the note section, would reveal a record of chronologically summarized correspondence. If more than one deal were pending with that prospective borrower or client, specifics about each deal would be viewable by “clicking” the note summary.

The system, at step 316 performs an internal screening of its lending source database to create a list of prospective global lending sources that have previously indicated a willingness to see projects of the type at hand. The list automatically provides the name of the lending source; contact name and phone numbers, contact e-mail and fax number. Furthermore, by “clicking” on the name of any lending source, the GCS may view the entire file of the lending source. As in the case of the borrower's record, a main level for each lending source provides chronologically summarized notes for all correspondence with that particular lending source. “Clicking” on a summarized note for each deal permits viewing of the details for that deal. Additionally, if data is entered in the sub-file a summary of that information is posted for viewing at the main level.

Once the contact file is established at step 226, and the project file is established at step 310, the prospective borrower and the GCS discuss the project at step 312. If necessary, the GCS enters appropriate notations into the electronic file. If the GCS and the client agree to proceed with the transaction at step 312, the prospective borrower executes and returns the Exclusive Engagement Agreement and wire transfers (or tenders) the Processing Fee at step 318. The Processing Fee becomes the breakup fee if the client subsequently terminates the agreement. If the prospective borrower does not execute the Exclusive Engagement Agreement nor post the Processing Fee at step 318, then, at step 322, the project is suspended.

If the prospective borrower does execute the Exclusive Engagement Agreement and posts the Processing Fee, he/she becomes a client at step 318. At step 320, the GCS obtains from the client the documents that are needed to prepare the Summary Project Data Files (SPDF) and the Complete Project Data Files (CPDF). This data may be provided by the client in traditional paper format or in electronic form.

The GCS, at step 322, 324 or 326 depending on the project type, reviews the client's data and works with the client to put the data into a form suitable for use by the system. At step 320, the GCS also performs basic due diligence on the project. At step 322, 324 or 326, the GCS prepares the on-line SPDF and CPDF data files. This information may be formatted as either a hypertext markup language (HTML), portable document format (PDF), Graphics Interchange Format (GIF), Joint Picture Experts Group (JPEG) file or other file type that accommodates both graphics and text. The formatted file is placed on the server where it is linked to the client's main file. All projects that are associated with a given client are accessible from the client's main file.

At step 332, if the project is for an equipment lease transaction, the appropriate SPDF and CPDF are created. If the client data are to be used for select banking or commercial real estate financing then the SPDF and CPDF for those transactions are created at steps 324 and 326, respectively. Next, at step 328, the client reviews the contents of the SPDF and CPDF. If these files are acceptable, the client approves them and, at step 330, the GCS orders the appropriate third party reports via the system. If at step 328 the files are not acceptable, the client works with the GCS until they are.

After step 328, the GCS orders the appropriate third-party reports for the project via the system at step 330. A significant differentiating feature the present invention relative to prior financing methods is its ability to compress the lending process. One of the ways it accomplishes that is to provide all third party due diligence documentation on-line for immediate review by lending sources. A second component of the Company's business model that saves time is the company's practice of ordering the necessary reports—the building or equipment appraisal, the engineering report and the environmental report—from third party agents at step 330 shortly after the prospective borrower is engaged as a client and approves the SPDF and CPDF at step 328.

By ordering these reports at the beginning of the lending process, instead of after a lending source has been chosen, the overall time it takes to complete and fund a loan request is reduced. Increasing a client's timeliness of success is a unique advantage that the business model of the subject invention offers both borrowers and lenders.

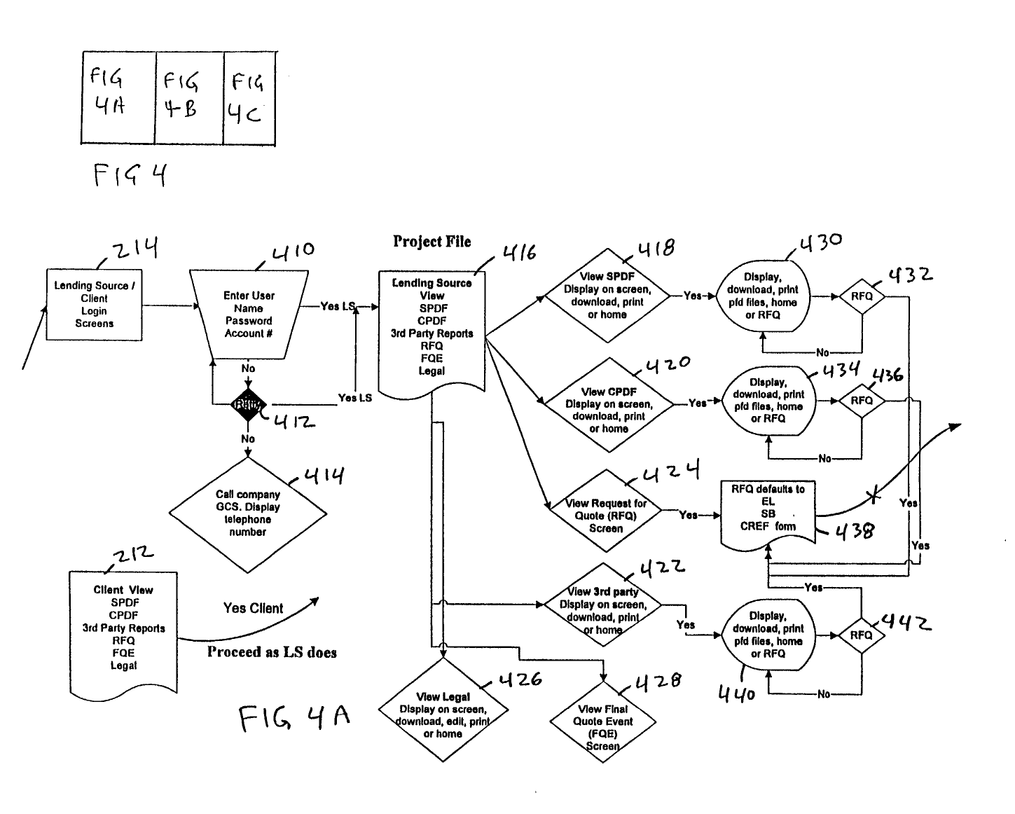

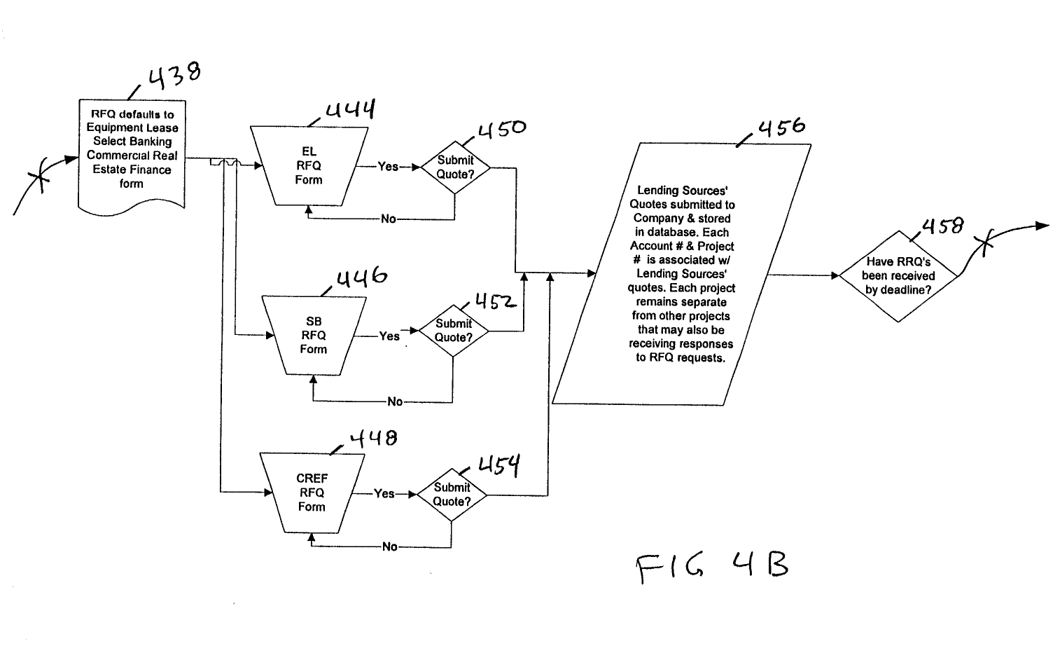

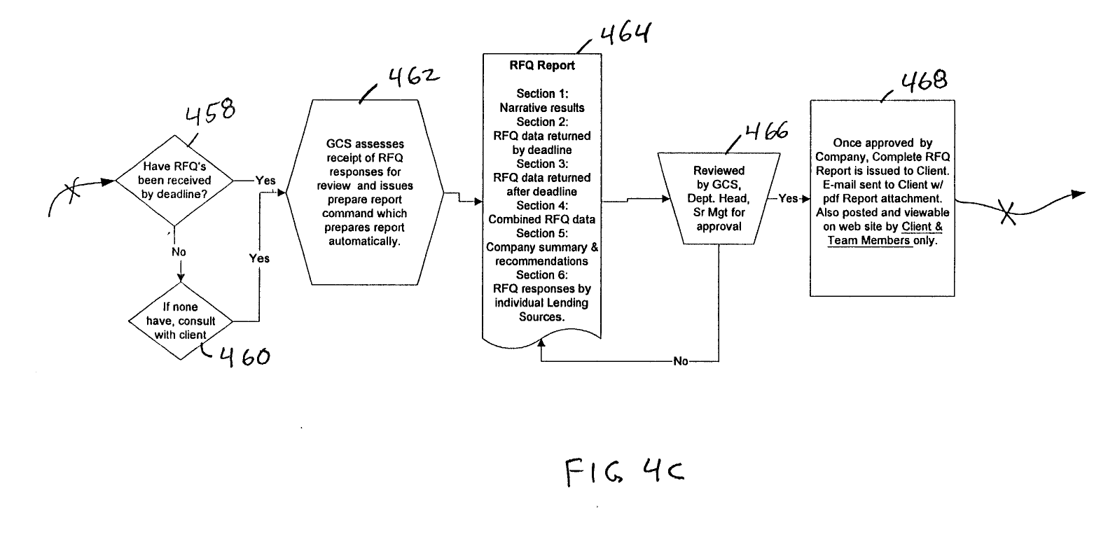

Next at step 332, the global lending sources who appear on the internally generated preliminary list are sent a personalized, simple e-mail stating that Because “you” (lending source) had expressed an interest in reviewing certain types of loans, “you” are invited to preview this offering describing a (type of loan) for $x, located in town, state, country. Please select a link in the e-mail message to preview the project summary. Lending sources that select the displayed link are taken directly to the company's web site at step 214 of FIG. 4A, and directly to a specific project file. They are prompted to enter security codes to include name, the company's name, e-mail address and project number at step 410. If any information is entered incorrectly, the lender may either retry entry, at step 412, or call the company for assistance.

Once the lending sources have completed those steps, then at step 416 the SPDF is displayed on the web site. These files may contain, for example, a project narrative, condensed financial data, pictures and maps. The lender may also view any third party reports that have been received. In addition, the lender may choose to submit a request for quote (RFQ) or register to participate in the final quote event (FQE). Finally, from step 416, the lender may view the legal details of the deal at step 426. This entry point may be used after the FQE to prepare and review the legal documents that conclude the transaction.

At steps 418, 420 and 422, if the lender asks to preview the respective SPDF, CPDF and third party reports, these reports may be displayed on screen, saved to their file, and/or printed it out at the respective steps 430, 434 and 440. After reviewing and/or downloading the SPDF at step 430, the CPDF at step 434 or the third party reports, at step 440, the lender, at step 432, 436 and 442, respectively is asked if her or she would like to submit a preliminary quote by filling out a request for quote (RFQ) form. The lender may also request the RFQ form directly from step 416 via step 424. If the lender requests the RFQ for by any of these means, then, at step 438 the appropriate RFQ form: equipment lease (EL), select banking (SB) or commercial real estate finance (CREF), is presented to the lender.

Referring to FIG. 4B, at step 438 and based upon the information in hand, the lender can submit a preliminary quote on line via the web site by entering the loan terms they would offer on the Request For Quote (RFQ) form, for either commercial/resort real estate, steps 448 and 454, equipment leasing, steps 444 and 450, or select bank loans, steps 446 and 452. Next at step 456 the quotes submitted by the lending sources are posted to the project file, and a summary is posted to the main correspondence section of each lender's file. When viewing the project files, company personnel and management are able to call up responses from lending sources that have quoted on a specific project. Additionally, when reviewing a lender's file for volume or for responses to RFQ's, management can review all responses that each lending source has provided since being contacted initially.

Referring to FIG. 4A, if the lending sources determine that they need more information than what is available to them via the SPDF, they have the option, at step 416, of downloading the CPDF, which includes a complete Financial Information file for the project, by clicking the appropriate “button” for commercial/resort real estate, equipment leasing or select banking lines of credit and loans. Financial information, including, three years of trailing balance sheet and profit and loss data, as well as current rent roll summaries, projected cash flow and a current year operating budget are available for downloading. The complete financial information file is formatted on financial reporting software provided by a strategic partner, and not on software developed by the Company. The strategic partner's software is contained within the complete project data file associated with the specific project that lending sources are requesting to review. Exemplary financial reporting is available from Argus or Moodys.

When downloading the financial information contained within the CPDF at step 434 in the format of the strategic partner, if the lending sources do not have the software, they receive a “trial” version from the strategic partner. Once downloaded onto their computer, the “trial” version permits the lending sources to utilize the strategic partner's software to open, read, manipulate, print out and save the complete financial file on the project that they downloaded from the company. The strategic partner is simultaneously notified of any lending sources, that have received the “trial” version, and those lending sources become prospects for the strategic partner to sell one or more complete copies of its software. The strategic partner receives the lender's name, contact name, phone number, e-mail address, etc. automatically without the company having to take the time and assign someone on staff to transfer that data to the strategic partner. The company then opens a file on its server to track information on this lending source and on all lending sources who have received leads and have subsequently downloaded the “trial” version of the software.

If lending sources need additional historical records such as appraisals on buildings and equipment, environmental and engineering reports, subject company data, additional photographs, comparable market data (for real estate), management contracts and other due diligence documentation, they may obtain it from the CPDF. Lending sources effectuate accessibility to the file once the appropriate security hurdles are cleared. These documents are formatted as a single encrypted, compressed file, which requires a password to open. An index notes which documents are formatted, for example, as PDF files and which ones are formatted as third party software files. In the exemplary embodiment of the invention, the PDF files do not permit modification by lending sources, but the third party financial files are designed to permit modification.

Lending sources that submit RFQ's have their responses transmitted to the company via the Internet at step 456 and filed under the project and under the lending sources' files.

The SPDF that the lending sources review when responding to the initial e-mail contains a cover letter thanking them for their interest in financing the project and explains to them the procedure and timelines for submitting their RFQ. Compliance within the time schedule is critical. All lending sources that respond with a preliminary quote within the timeline established have their responses posted to a file for comparison to other lending sources' responses. At step 458 the system determines if the RFQ's have been received by the deadline. Lending sources that quote after the response date are posted to the same file but to a section noting their response was received after the bid submission date. If all of the RFQ's are late, the GCS consults with the client, at step 460 to determine whether these submissions should be considered.

The GCS responsible for the transaction assesses the various RFQ's at step 462 and causes the system, at step 464 to prepare a report. This report is then reviewed by the GCS and his/her supervisors. Once the report is approved, the GCS, at step 468, communicates with the client in person, on-line or by telephone to discuss the responses from the various lending sources. Statistical information is also made available to the client at step 468 in the form of a report noting the number of e-mails sent, lending sources' response timeline, whether the responses were in compliance with the terms sought by the client according to the various components of their quotes. For example, were 100% of the responses at or less than the interest rate sought by the client? What percentage of the loan amounts offered by the lending sources were less than, equal to or greater than the amount sought by the client? The statistical data is part of the report issued by the company to the client. The report also contains the company's suggestions noting which lending sources to invite to the interactive on-line, real-time Final Quote Event (FQE).

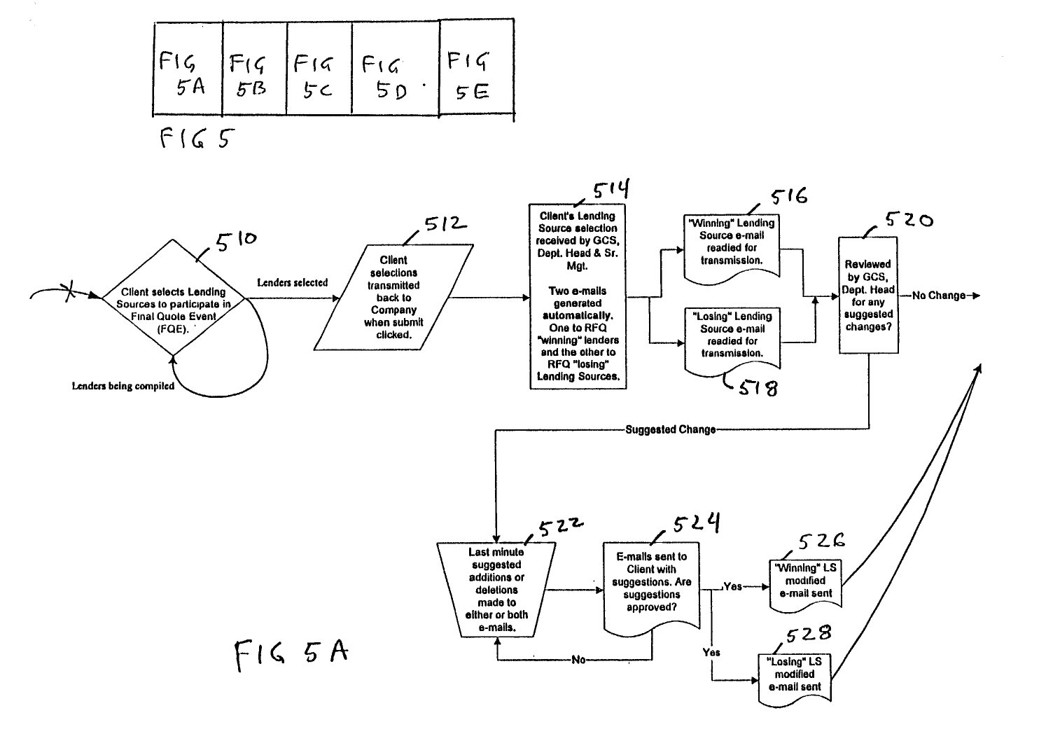

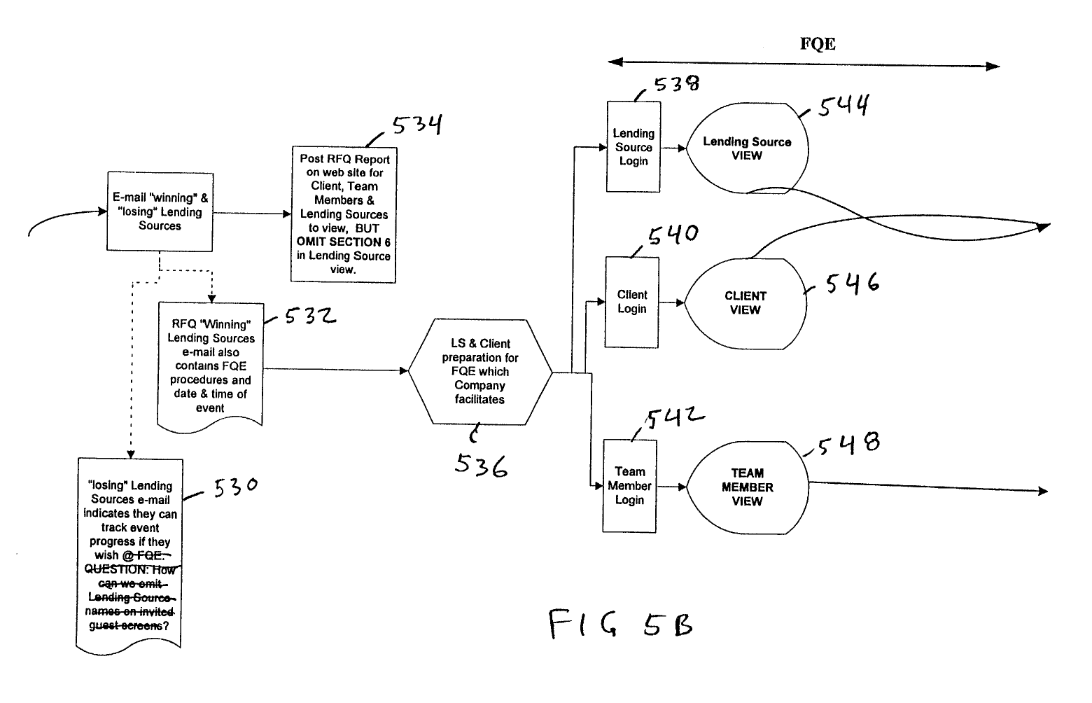

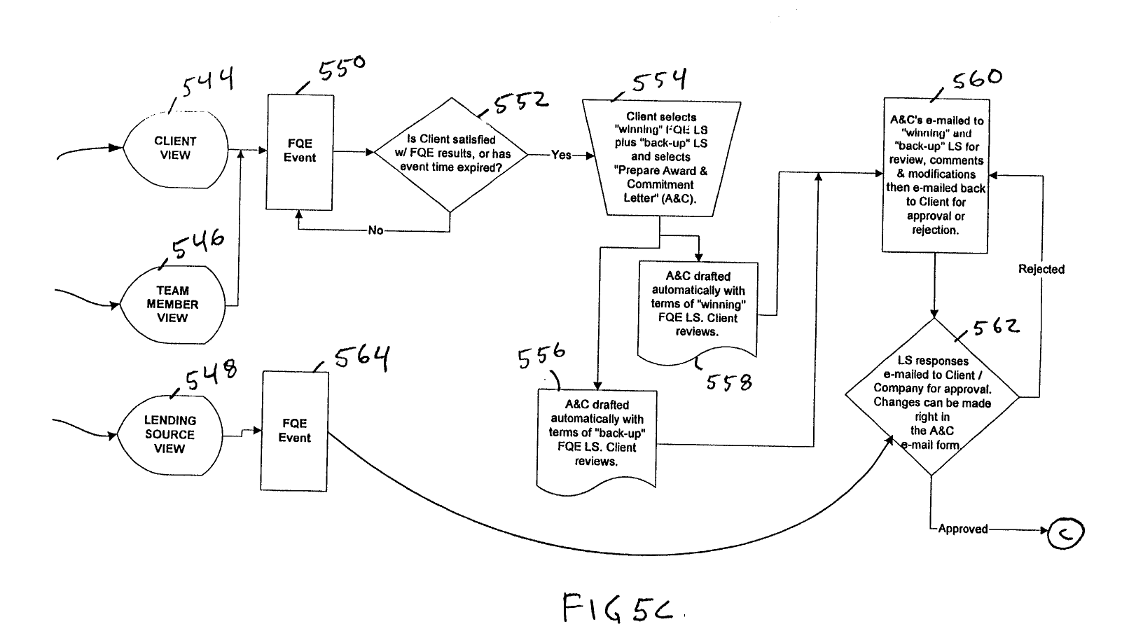

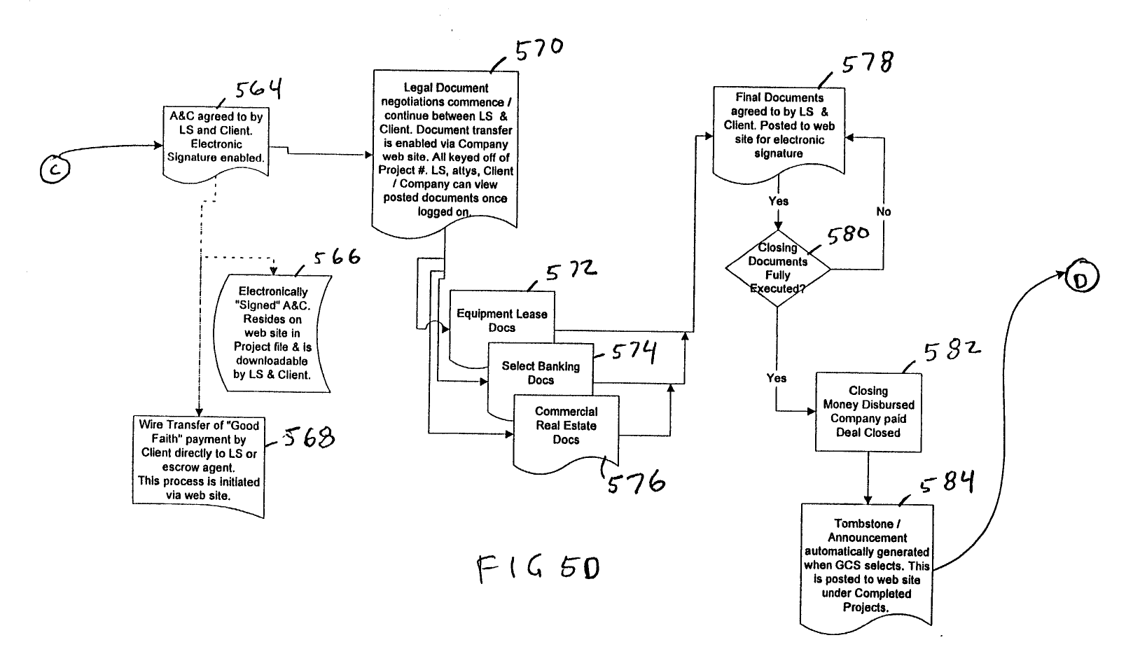

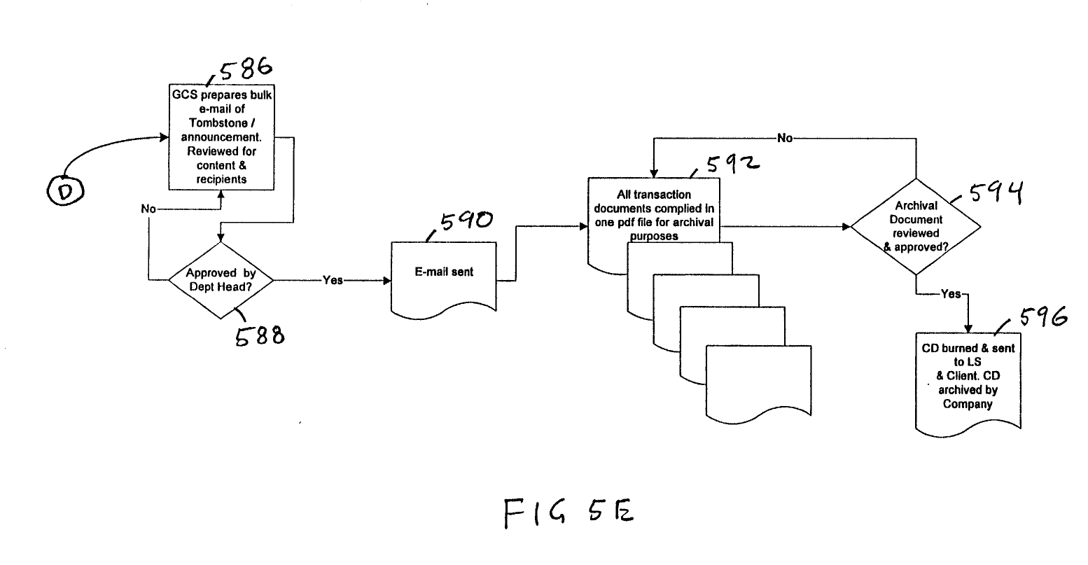

At step 510 of FIG. 5A, the system allows the client to select which lending sources will participate in the FQE. Once the lending sources have been selected they are transmitted back to the company at step 512. At step 514, the lending sources that were selected by the client are reviewed by the GCS and company management and, are notified as to the date and time and the procedure for participating. (All business days are based upon the US business calendar and times are Eastern Standard Time, EST.) The lending sources that are not selected are notified and an appropriate reason is given. Respective form letter responses allowing for customization are generated by the system and forwarded to the GCS at steps 516 and 518. The GCS and company management again review the selection of lending sources that will participate in the FQE. If they want to make changes, then, at step 522, the GCS and/or company management can add or delete lending sources from either or both of the sets of “winning” or “losing” e-mail messages. At step 524, the modified e-mail message sets are sent to the client for approval. After step 520 or 524, the “winning” and “losing” e-mail messages steps 526 and 528, respectively, are sent to the lending sources. The correspondence is posted to the lending source's files and to the project correspondence file.

As shown in step 532 of FIG. 5B, the winning e-mail messages contain the FQE procedures and the date and time of the event. The losing e-mail messages invite the losing lending sources to track the event progress by viewing, but not participating, in the FQE.

After the winning and losing e-mail messages have been sent, the RFQ report listing the client, the company team members who will conduct the FQE and the participating lending sources is posted on the web site for the client and GCS to view (lending sources are not permitted to view the list). In addition, an interim notice is e-mailed reminding the lending sources of the date and time for the FQE. The GCS is prompted by an automatic reminder from his/her networked calendar to verify that the winning lending sources were notified of the FQE, and to answer any questions they might have before the event.

If lending sources have not previously downloaded the CPDF, or additional historical records pertaining to a project, they can do so between acceptance of their RFQ the and the FQE date by logging on to the company web site, as described above. This is illustrated by step 536 in FIG. 5B. During this time, lending sources may conduct initial or additional due diligence. Because this model rewards lending sources that perform with greater efficiencies and penalizes those who cannot improve their response times, lending sources that have prepared for the FQE should perform well when compared to those lending sources that did not.

The FQE is conducted via the Internet on the company web site. Participants include the RFQ winning lenders, the client and invited guests, if any. Access by participants to the Project is permitted once his/her name, company name and e-mail address and project number are entered. The lending source logs in at step 538, the client logs in at step 540 and the company team member logs in at step 542. At a predetermined time, the FQE begins.

At step 544, during the FQE, each lending source sees, on their screen the components of their RFQ and beside it the “best” components of the loan quote taken from other RFQ's. This split screen permits a lending source to see how their RFQ fares in comparison to each component making up the loan quote. A correspondence or “chat” section facilitates communication between individual lending sources and the team member or GCS, who views the process at step 548, in a secure, private way that other lending sources and invited guests can not see. The option to permit the client to “see” what The company “sees” on its screen or screens at step 546 is desirable in the case where a client wants to watch the bid event from a remote location. A voice link with each lending source may also be used. At the company office, each lending source's activity is viewable on one or more monitors in the conference room.

While the company conducts the FQE, at step 550 of FIG. 5C, the client views the activity and interacts with the GCS and any lending source it chooses to. After a predetermined time has elapsed the client makes his final selection, at step 554 the lending source with the “best” quote is selected. The client also chooses a “runner-up,” and the session is closed. The lending sources not selected are immediately notified by letter and/or e-mail describing the “winning” bid terms. They are thanked for their participation and told that they will be notified of the next event. The winning lending source and runner-up are e-mailed a company Award & Commitment (A&C) letter at steps 558 and 556, respectively. The A&C letter contains the terms committing the lending source to book or block deal funds for a date certain closing. The winning lending source negotiates with the client through e-mail messages transmitted through the system at steps 560 and 562 until both the lending source and the client approve the terms of the A&C letter. At this point, the lending source electronically executes the A&C letter, at step 564 of FIG. 5D, and sends it back to the company. Upon execution and return of the A&C letter a copy is filed, at step 566, in the respective files for the client, project and lending source files. At step 568, a wire transfer of a “good faith” payment is sent by the client directly to the lending source or to the escrow agent, depending on the terms of the agreement between the client and the lending source.

If the third party reports had not been completed prior to the FQE, the winning lending source is notified when they will be available to him/her to complete his/her due diligence. Because those reports were started shortly after the Exclusive Engagement Agreement was executed, their completion should coincide with the FQE or be available before the event begins. When available, those reports are posted on-line and the lending source is notified of their availability. At steps 570 and 572, for equipment leases; 574 for select loans; and 576 for commercial real estate loans, the legal documents are prepared by the lending source and sent to the client. The company uses standard legal documents that may be utilized with or instead of lending source's legal documents.

The client, the company and the lender complete the documentation as agreed between all parties at steps 578 and 580. At step 582, the loan is funded, and the company is compensated.

At step 584, the system automatically generates the tombstone announcement and posts the announcement to the web site as a completed project. At step 586 of FIG. 5E, the system prepares a bulk e-mail of the tombstone announcement for review by the GCS and company management. When the e-mail announcement is approved at step 588, it is sent at step 590. Finally, at steps 592 and 594, all of the transaction documents are compiled, for example, in a single PDF file which is reviewed and approved by the company, the lending source and the client. This document is then “burned” onto a writeable medium such as a compact disk read-only memory (CDROM), at step 596, copies of which are sent to the lending source and the client. In addition, the company maintains a copy in its archives.

Internally, the company performs a best practices review of the transaction and prepares internal comments for staff to comment upon.

It is contemplated that this invention may be implemented in computer software residing on a computer readable carrier such as a magnetic or optical disk or as a radio-frequency or audio frequency carrier wave.

While the invention has been described in terms of an exemplary embodiment, it is contemplated that it may be practiced as described above within the scope of the attached claims.

The invention claimed is:

1. A computer assisted method for negotiating loans on behalf of a borrower comprising the steps of:
a) collecting data describing a requested loan transaction from the borrower;
b) electronically notifying a plurality of lenders of the requested loan transaction and inviting each lender to electronically submit a corresponding request for quotes for the loan transaction to provide a respective plurality of requests for quotes;
c) providing the plurality of requests for quotes in electronic form for review by the borrower;
d) receiving, from the borrower, multiple requests for quotes selected from the plurality of requests for quotes, and inviting the corresponding lenders to participate in a final quote event; and
e) conducting the final quote event among the borrower and the chosen lenders, including the steps of:
e1) displaying the multiple requests for quotes to the borrower;
e2) displaying to each participating lender information on the request for quote of the lender and the best terms from among the multiple requests for quotes; and
e3) presenting each lender with options to improve their corresponding request for quote;
f) receiving a selection from the borrower of one request for quote of the multiple requests for quotes as the final quote.

2. A computer assisted method for negotiating loans on behalf of a borrower according to claim 1, wherein the negotiations are conducted via a global information network and wherein:
step a) includes presenting a form on a web site to the borrower and receiving the form containing the data provided by the borrower; and
step b) includes sending an electronic mail (e-mail) message to the plurality of lenders describing the loan transaction, wherein the e-mail message includes a hyperlink to the web site containing the data provided by the borrower, and providing the plurality of lenders with a corresponding plurality of form requests for quotes via the web site.

3. A computer assisted method for negotiating loans on behalf of a borrower according to claim 1, further comprising the steps of:
ordering any third party documents needed to analyze the loan transaction immediately after collecting the data describing the loan transaction from the borrower; and
receiving the ordered third party documents, converting the received documents to electronic form and providing the documents for review by the multiple lenders prior to the final quote event.

4. A computer assisted method for negotiating loans on behalf of a borrower according to claim 3, wherein the negotiations are conducted via a global information network and wherein:
step a) includes presenting a form on a web site to the borrower and receiving the form containing the data provided by the borrower;
step b) includes sending an electronic mail (e-mail) message to the plurality of lenders describing the loan transaction, wherein the e-mail message includes a hyperlink to the web site containing the data provided by the borrower, and providing the plurality of lenders with a corresponding plurality of form requests for quotes via the web site; and
the step of providing the documents for review by the multiple lenders includes the step of posting the documents on the web site.

5. A computer assisted method for negotiating loans on behalf of a borrower according to claim 1, further comprising the steps of:
sending the lender corresponding to the selected final quote a commitment letter in electronic form; and
receiving from the lender corresponding to the selected final quote the commitment letter with an electronic signature indicating acceptance of the loan transaction;

6. A computer assisted method of negotiating loans on behalf of a borrower according to claim 5, further comprising the steps of:
preparing legal documents to complete the loan transaction in electronic form after the signed commitment letter is received;
obtaining electronic signatures on the legal documents from the borrower and from the lender corresponding to the final quote; and
preparing an electronic record of the transaction including the data provided by the borrower, the final quote, the signed commitment letter and the signed legal documents and distributing the electronic copy to the borrower and to the lender corresponding to the final quote.

7. A computer system for negotiating loans on behalf of a borrower comprising:
means for electronically collecting data describing a requested loan transaction from the borrower;
means for electronically notifying a plurality of lenders of the requested loan transaction and for inviting each lenders to electronically submit a corresponding request for quotes for the loan transaction to provide a respective plurality of requests for quotes;
means for providing the plurality of requests for quotes in electronic form for review by the borrower;
means for receiving, from the borrower, multiple requests for quotes selected from the plurality of requests for quotes, and inviting the corresponding lenders to participate in a final quote event; and
means for conducting the final quote event among the borrower and the chosen lenders, including:
means for displaying the multiple requests for quotes to the borrower;
means for displaying to each participating lender information on the request for quote of the lender and the best terms from among the multiple requests for quotes; and
means for presenting each lender with options to improve their corresponding request for quote;
means for receiving a selection from the borrower of one request for quote of the multiple requests for quotes as the final quote.

8. A computer system according to claim 7, wherein the means for collecting data from the borrower, the means for providing the plurality of requests for quotes for review by the borrower, and the means for conducting the final quote event include respective web pages of a web site on a global information network, the means for electronically notifying the plurality of lenders, the means for receiving the multiple requests for quotes from the borrower and the means for receiving the selection of the final quote include an e-mail system on the global information network.

9. A computer readable carrier including computer program instructions that cause a general purpose computer to perform method for negotiating loans on behalf of a borrower, the method comprising the steps of:
a) collecting data describing a requested loan transaction from the borrower;
b) electronically notifying a plurality of lenders of the requested loan transaction and inviting each lenders to electronically submit a corresponding request for quotes for the loan transaction to provide a respective plurality of requests for quotes;
c) providing the plurality of requests for quotes in electronic form for review by the borrower;
d) receiving, from the borrower, multiple requests for quotes selected from the plurality of requests for quotes, and inviting the corresponding lenders to participate in a final quote event; and
e) conducting the final quote event among the borrower and the chosen lenders, including the steps of:
e1) displaying the multiple requests for quotes to the borrower;
e2) displaying to each participating lender information on the request for quote of the lender and the best terms from among the multiple requests for quotes; and
e3) presenting each lender with options to improve their corresponding request for quote;
f) receiving a selection from the borrower of one request for quote of the multiple requests for quotes as the final quote.
